(19) United States
(12) Patent Application Publication
(10) Pub. No.: US 2006/0267769 A1
(43) Pub. Date: Nov. 30, 2006

(54) Terminal device and communication system

(75) Inventors: Masafumi Ito, Atsugi (JP); Konami Izumi, Atsugi (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 11/432,348

(22) Filed: May 12, 2006

(30) Foreign Application Priority Data
May 30, 2005 (JP) 2005-158229

(51) Int. Cl. G08B 13/14

(52) U.S. Cl. 340/572.1

(57) ABSTRACT

One of the objects of the present invention is to provide a communication system in which a user in a specific area can obtain information immediately without operating a device. The communication system has an RFID card, a reader/writer for communication, a host computer, and an information communication means. The RFID card transmits and receives information wirelessly to and from the reader/writer for communication. Thus a user can carry the RFID card freely. The memory portion in the RFID card has a rewritable memory portion and a non-writable memory portion. Electric power required for operation of the RFID card is supplied wirelessly, which contributes to reduction is size and weight of the RFID card. By providing a display portion in the RFID card, information transmitted wirelessly can be displayed on the display portion and the user can recognize information immediately.

### BACKGROUND OF THE INVENTION

1. Field of the Invention

The present invention relates to a terminal device for wireless communication and a communication system including the terminal device.

2. Description of the Related Art

As informatization progresses, to get information immediately is emphasized in social life. Therefore, the development of a communication system such as an email or a portable phone has been carried out actively. In addition, the number of users of such a communication system is increasing.

For example, an information communication system is known in which a portable wireless communication terminal can be used for transmitting and receiving information sent by an email or a facsimile as well as used as a telephone, in addition, the sent information can be shared by a plurality of users (for example, see Patent Document 1).

Japanese Patent Laid Open No. H11-46245

However, with an email which is given as an example of the foregoing communication system, reception of an email and the information thereof cannot be checked until a user starts a computer and operates email software. In addition, a portable phone needs to be carried in order to answer the phone. Further, the portable phone cannot be used in a public place such as a theater, a concert hall, and a train in some cases; therefore, the portable phone does not always serves as a communication system to get information immediately.

In an information society, there is a case where speed of getting information is required. For example, in a company, a hospital, a public office, and the like, there is a case where a contact is needed to be made immediately during working hours. For example, there may be an unscheduled meeting, an unscheduled guest, a sudden change in a patient's condition, and the like.

### SUMMARY OF THE INVENTION

In view of the foregoing, one of the objects of the present invention is to provide a terminal device in which a user can obtain information immediately without operation when the user is in the specified area. In addition, it is another object of the present invention to provide a terminal device which does not have a power supply, has a small size, and operates with low power consumption so as to be always carried out by the user, and a communication system including the terminal device.

The terminal device of the present invention transmits/receives information by wireless communication and has a display portion to display the information.

A deice which transmits/receives information by wireless communication is called an RFID (Radio Frequency IDentification) card (also referred to as an RFID tag, an IC tag, an IC chip, an RF tag, a wireless tag, an electric tag, and a transponder) and the like. Thus, the present invention provides an RFID card with a display portion. That is, the terminal device of the present invention (an RFID card) has a display portion and a circuit for wireless communication (such as a high frequency circuit, a booster circuit, a logic portion, and a memory portion).

The terminal device of the present invention has an optical sensor. The optical sensor detects light (external light) in an environment where the terminal device is used. The terminal device controls the brightness of the display portion according to the detected amount of light (information).

The memory portion has a rewritable memory portion and a non-rewritable memory portion. In the non-rewritable memory portion, terminal device-specific information which is stored in the terminal device in advance is read out. In the rewritable memory portion, information which is obtained by wireless communication is written to and read from.

The frequency used for wireless communication can be any of a submillimeter wave of 300 GHz to 3 THz, a millimeter wave of 30 GHz to 300 GHz, a microwave of 3 GHz to 30 GHz, an ultrahigh frequency of 300 MHz to 3 GHz, an ultrashort wave of 30 MHz to 300 MHz, a short wave of 3 MHz to 30 MHz, a medium wave of 300 KHz to 3 MHz, a long wave of 30 KHz to 300 KHz, and an ultra-long wave of 3 KHz to 30 KHz.

The present invention particularly relates to a terminal device which is formed with an element such as a transistor formed over an insulating substrate. In addition, the present invention also relates to a terminal device in which a display portion, a circuit for wireless communication (such as a high frequency circuit, a booster circuit, a logic portion, a memory portion), and the like are formed over one substrate.

In addition, the present invention relates to an information processing unit which controls wireless communication with the terminal device. In addition, the present invention relates to a communication system having the terminal device and the information processing unit. The information processing unit has a reader/writer for communication which transmits and receives information to and from an RFID card, a host computer which is connected to the reader/writer for communication, an information communication means for inputting/outputting information to/from the host computer

In addition, the reader/writer for communication has a memory portion and a logic portion. Thus, information can be transmitted and received between the reader/writer for communication and the RFID without transmitting and receiving information to and from the host computer.

In the terminal device of the present invention, the RFID card has a display portion so that information received by wireless communication can be displayed on the display portion, the user thus can recognize the information immediately.

The terminal device of the present invention has an optical sensor. The optical sensor detects light in an environment where the terminal device is used. The brightness of the display portion is controlled according to the detected information. Thus, the brightness of the display portion can be changed to make the display easy to be read. Therefore, it is possible for the user to recognize information accurately.

The terminal device of the present invention has a memory portion having a rewritable memory portion and a non-rewritable memory portion, which are used for each purpose. In general, a rewritable memory portion operates slower than a non-rewritable memory portion. In the present invention, those two memory portions are used, thereby, information can be written while reading speed of specific information can be increased. Therefore, the user can recognize information immediately.

The terminal device of the present invention can be reduced in weight and size by being formed with an element such as a transistor formed over an insulating substrate. In addition, the terminal device of the present invention can be further reduced in weight and size by forming the display portion in the terminal device of the present invention and a circuit for wireless communication (such as a high frequency circuit, a booster circuit, a logic portion, a memory portion) over one substrate. Thus, the user can carry the terminal device more easily and obtain information accurately.

Information is transmitted and received between the reader/writer for communication and the RFID card without transmitting and receiving information with the host computer. Therefore, the user can obtain information immediately.

As described above, the user can obtain information immediately and accurately with the terminal device and the information processing unit of the present invention, and the communication system having the terminal device and the information processing unit.

### BRIEF DESCRIPTION OF DRAWINGS

FIG. 1 shows a structure of a communication system of the present invention;

FIG. 2 shows a structure of a high frequency circuit of the present invention;

FIG. 3 shows a structure of a logic portion of the present invention;

FIG. 4 shows a structure of a memory portion of the present invention;

FIG. 5 shows a structure of a high frequency circuit of the present invention;

FIG. 6 is a flow chart showing a process of outputting information from an information communicating means to a host computer;

FIG. 7 shows an operation of a host computer of the present invention;

FIG. 8 shows a structure of an RFID card of the present invention;

FIG. 9 shows a structure of an RFID card of the present invention;

FIG. 10 shows a structure of an RFID card of the present invention;

FIG. 11 shows a structure of an RFID card of the present invention;

FIG. 12 shows a business model of the present invention;

FIG. 13 shows a business model of the present invention;

FIG. 14 is a cross-sectional view of a structure of an element in a communication system of the present invention;

FIGS. 15A to 15E are top views of a structure of an element in a communication system of the present invention;

FIGS. 16A and 16B show a manufacturing step of an element in a communication system of the present invention;

FIGS. 17A and 17B show a manufacturing step of an element in a communication system of the present invention; and

FIGS. 18A and 18B show a manufacturing step of an element in a communication system of the present invention.

### DETAILED DESCRIPTION OF THE INVENTION

Hereinafter, the embodiment modes of the present invention will be described with reference to the accompanying drawings. The present invention can be carried out in many different modes, and it is easily understood by those skilled in the art that modes and details herein disclosed can be modified in various ways without departing from the purpose and the scope of the present invention. Accordingly, the present invention should not be interpreted as being limited to the description of the embodiment modes to be given below. Note that in the drawings, the same reference numerals are used for the same portions or the portions having the same functions.

### Embodiment Mode 1

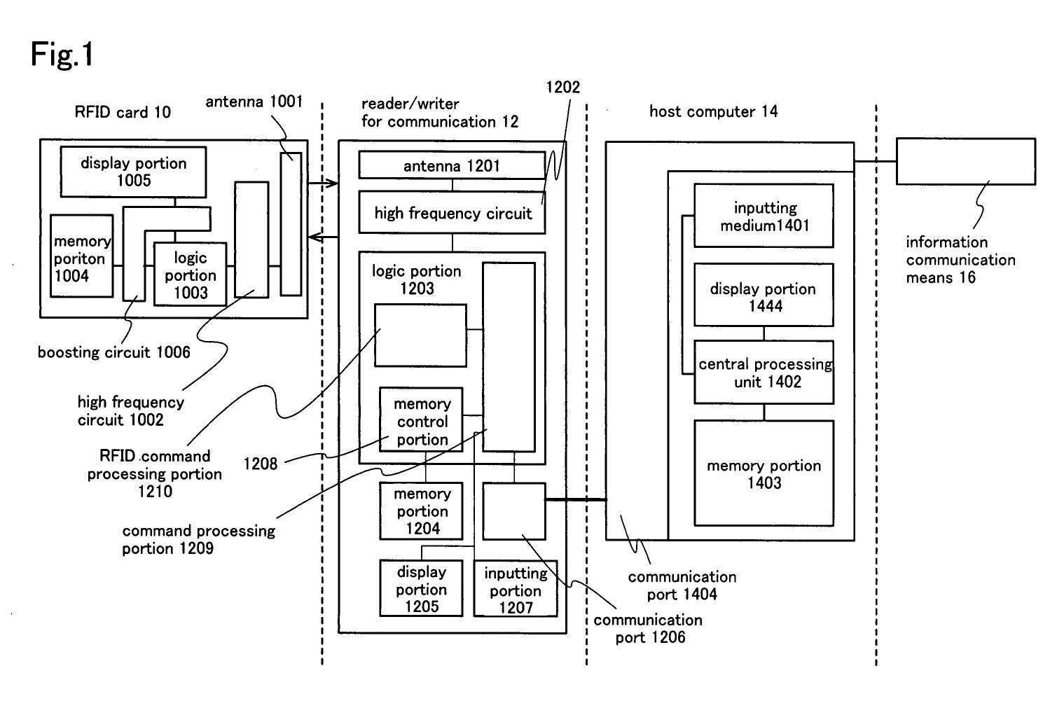

A structure of a communication system of the present invention is shown in FIG. 1. The communication system has an RFID card 10, a reader/writer for communication 12, a host computer 14, and an information communication means 16. The RFID card 10 corresponds to a terminal device. In addition, the reader/writer for communication 12, the host computer 14, and the information communication means 16 correspond to an information processing device for controlling wireless communication.

In FIG. 1, the RFID card 10 transmits and receives information wirelessly to and from the reader/writer for communication 12, which enables a user to carry the RFID card 10 which is a terminal freely. In addition, by applying wireless communication, electric power needed for operation of the circuit can be generated in the RFID card 10. That is, a battery or the like is not necessarily provided in the RFID card 10. Therefore, the RFID card 10 can be made smaller and lighter. In addition, a portable terminal device including the RFID card 10 can be made smaller and lighter, thereby the portable terminal device can be carried more easily.

The communication system shown as an example in FIG. 1 can give various information to users. In this Embodiment Mode, by using the RFID card 10, communication can be carried out without an intense electromagnetic wave. For example, according to the present invention, information can be easily exchanged using an electromagnetic wave, even in a place where the use of a portable phone is not permitted.

In FIG. 1, the reader/writer for communication 12 communicates with the RFID card 10 wirelessly. In addition, the reader/writer for communication 12 transmits information to the RFID card 10 wirelessly while supplying electric power to the RFID card 10. The reader/writer for communication 12 is connected to the host computer 14 through an interface. As the interface, a USB (Universal Serial Bus), a serial interface, or the like is applied. It is needless to say that a connection form between the reader/writer for communication 12 and the host computer 14 is not limited thereto. The reader/writer for communication 12 has a function of interpreting a command or information transmitted from the host computer 14 to transmit the command or information to the RFID card 10, and a function of interpreting information transmitted from the RFID card 10 to send the information to the host computer 14. The reader/writer for communication 12 is capable of supplying electric power to the RFID card 10 even in the case where a command is not transmitted to the RFID card 10. Therefore, even when the RFID card 10 waits for a command, the RFID card 10 can actively operate to enable a user to check the information.

In FIG. 1, a plurality of the readers/writers for communication 12 is connected to the host computer 14 through an interface port. The connection form is not limited thereto. The host computer 14 is connected to the information communication means 16 through an interface port. The host computer 14 interprets information from the information communication means 16 and transmits a command to the reader/writer for communication 12 in order to transmit the information to the RFID card 10. In addition, the host computer 14 stores information on whether the RFID card 10 responds or not and individual-identifying information stored in the RFID card 10 as data. In addition, the host computer 14 has a function of interpreting information from the RFID card 10 to transmit a command to a peripheral device connected to the RFID card 10 or the host computer 14. Since the host computer 14 can perform such a processing, an immediate response can be made. In addition, the response can be made immediately even when there are less people available such as in the middle of the night.

Subsequently, a function of the information communication means 16 shown in FIG. 1 is described. The information communication means 16 is connected to the host computer 14. The information communication means 16 can transmit information to the host computer 14 and can receive information from the host computer 14. Since the information communication means 16 can conduct immediate collection and communication of information to be transmitted, it is possible to transmit information to a user immediately.

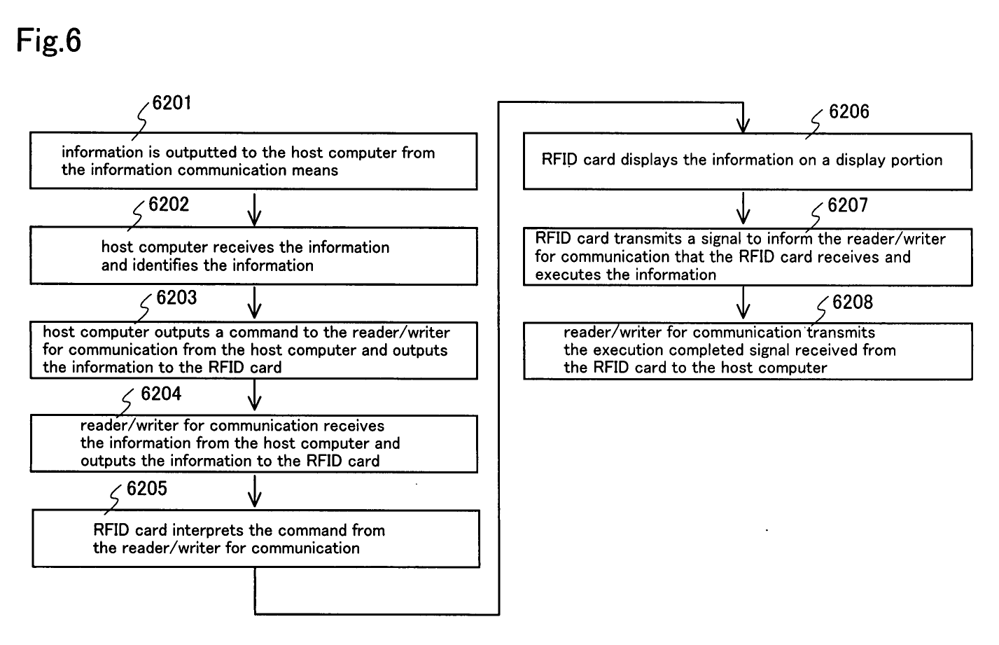

The function of the communication system is described above. Information is processed by combining each component. The flow chart of the processing is shown in FIG. 6. First, information is outputted to the host computer 14 from the information communication means 16 (a step 6201). Then, the host computer 14 receives the information and identifies the information (a step 6202). The host computer 14 outputs a command to the reader/writer for communication 12 so that the information is outputted to the specific RFID card 10 (a step 6203). The reader/writer for communication 12 receives the information from the host computer 14 and outputs the information to the RFID card 10 (a step 6204). The RFID card 10 interprets the command from the reader/writer for communication 12 (a step 6205) and displays the information on a display portion (a step 6206). The RFID card 10 transmits a signal to inform the reader/writer for communication 12 that the RFID card 10 receives and executes the information (a step 6207). The reader/writer for communication 12 transmits the execution completed signal received from the RFID card 10 to the host computer 14 (a step 6208).

This communication system provides a terminal device which is small and operates with low power consumption so as to be carried by a user easily. The communication system allows a user in a specific area to get information without a specific operation of the terminal device in a situation in which the user is required to get information immediately.

Note that although this communication system using the RFID card 10 performs wireless communication, an intense radio wave such as used for a portable phone is not used. In addition, ring alert or the like is not generated. Therefore, one feature of this communication system is to enable a user to get information immediately even in a situation in which the use of a portable phone is limited. Hereinafter, the component of this communication system is described in detail.

(A Structure of an RFID Card)

The RFID card 10 shown in FIG. 1 communicates with the reader/writer for communication 12 wirelessly through an electromagnetic wave. That is why an antenna 1001 is provided. The RFID card 10 has a high frequency circuit 1002 such as a resonance circuit for converting an electromagnetic wave from the antenna 1001 into current or a voltage signal, and a rectifier circuit for obtaining electric power for driving the RFID card 10. Since the RFID card 10 has the rectifier circuit, an internal power source is not required to be provided in the RFID card 10, which leads to reduction in size of the RFID card 10. In addition, the high frequency circuit 1002 includes a demodulation circuit for taking a command signal or the like from a signal from the antenna 1001 and a modulation circuit for generating a signal for transmitting information to the reader/writer for communication 12.

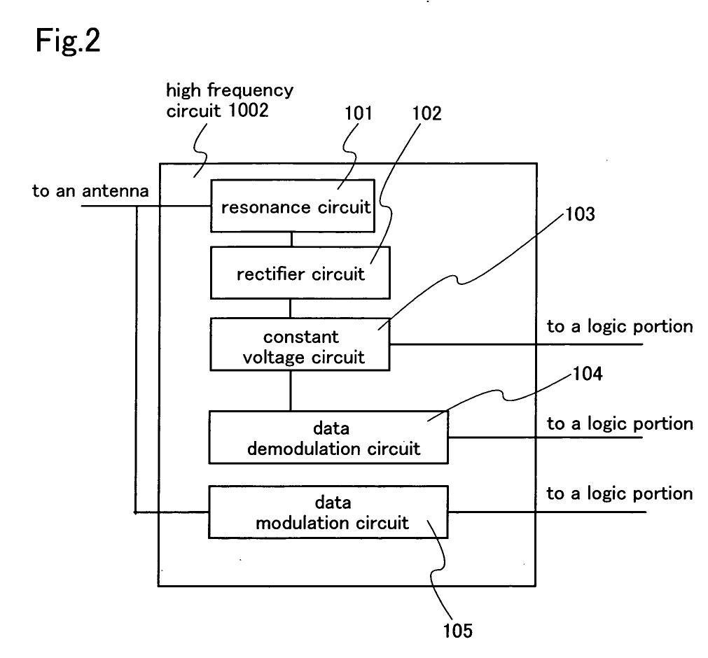

FIG. 2 shows a detail view of the high frequency circuit 1002. The high frequency circuit has a resonance circuit 101 for converting an electromagnetic wave from the antenna 1001 into current or a voltage signal. The voltage signal generated in the resonance circuit 101 is transmitted to a rectifier circuit 102 for generating electric power to drive a circuit and a constant voltage circuit 103. Further, a signal taken from the antenna 1001 is transmitted to a data demodulation circuit 104. In the data demodulation circuit 104, a command signal or the like is taken out and is transmitted to a logic portion. Information from the logic portion is modulated by a data modulation circuit 105 and transmitted to the reader/writer for communication 12.

The logic portion 1003 includes a circuit for generating a clock, a circuit for recognizing a command signal transmitted from the reader/writer for communication 12, a circuit for judging whether the signal is transmitted with accuracy, a circuit for judging whether the transmitted command is appropriate or not, a circuit for judging whether the transmitted command is executed or not, that is, whether an operation according to the transmitted command is executed or not by referring to information stored in a memory portion 1004 in the RFID card 10 (in other words, a circuit for verifying identifying information), and the like.

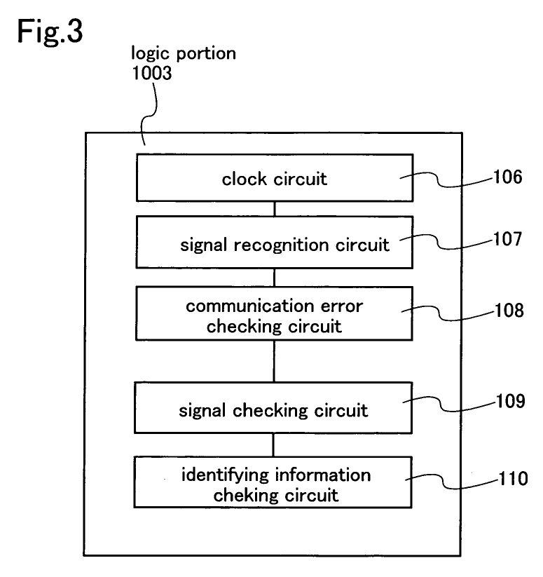

FIG. 3 shows a detail view of the logic portion 1003. A clock is generated in a clock circuit 106 according to the signal transmitted from the high frequency circuit. The logic portion 1003 has a signal recognition circuit 107 for recognizing a command signal from a signal transmitted from the high frequency circuit, a communication error checking circuit 108 for checking the presence or absence of errors in communication, and a signal checking circuit 109 for judging whether a command is appropriate or not. In addition, the logic portion 1003 includes an identifying information checking circuit 110 for judging whether the command is executed or not according to the individual-identifying information.

The memory portion 1004 includes a memory circuit and a memory controller for reading or writing data from or to the memory circuit. The memory controller receives a command from the logic portion 1003 to read or write information stored in the memory portion 1004. Then, the memory controller selects a memory of the specified address and supplies a voltage required for reading or writing to the memory circuit.

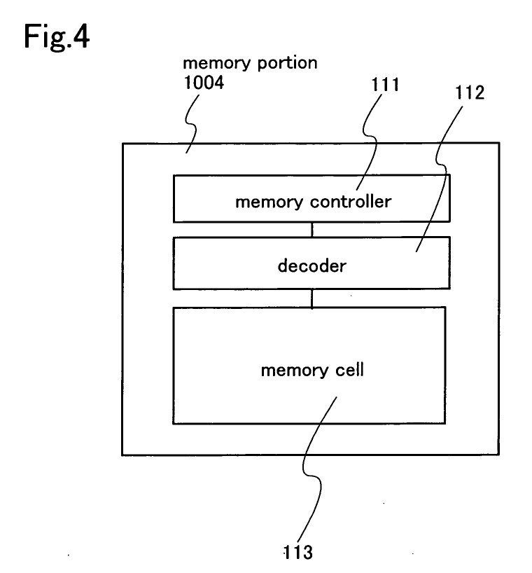

FIG. 4 shows a detail view of the memory portion 1004. In the memory portion 1004, a memory controller 111 outputs a command to read or write data from or to the memory. A decoder 112 supplies voltage to the specified address according to the command from the memory controller. In addition, information in the memory is read by a decoder portion. A memory cell 113 is connected to the decoder 112 and individual-identifying information is stored in the memory cell 113.

In addition, the RFID card 10 includes a boosting circuit 1006 for generating a high voltage required to drive a display portion 1005, the memory portion 1004, and the like. Therefore, power source can be supplied to each device included in the RFID card 10 by only the rectifier circuit in the high frequency circuit 1002. That is, a plurality of power generation circuits is not required to be incorporated in the RFID card 10; thereby a structure of the RFID card 10 can be simplified.

The display portion 1005 includes a display screen and a driver circuit for controlling the display screen. By providing the display screen, whether the RFID card 10 receives a signal or not can be seen visually, so that a user can know that he/she is called in the situation in which sound is not permitted. In addition, the user can see what kind of information has been given to the RFID card 10, for example, what kind of accident has happened, immediately by checking the display screen mounted over the RFID card 10. For example, in an emergency situation, detailed information about a paging signal can be transmitted to the RFID card 10 in addition to the paging signal itself. Therefore, the user can take immediate response without confirming the situation to the person in charge by phone or the like.

In addition, when there is a plurality of users of the RFID card 10, individual-identifying information including an individual-identifying number for identifying one user is stored in the memory portion 1004. In that case, the memory portion 1004 partially has a nonvolatile memory. As the nonvolatile memory, a rewritable memory such as an EEPROM, an FeRAM, a flash memory, and an MROM; a write-once organic memory; or the like can be used. It is possible to make all of the RFID cards 10 respond to the given command, or to make a specific RFID card 10 respond to the given command by storing the individual-identifying information in the memory portion 1004.

The RFID card 10 can be formed with a thin film transistor over a flexible substrate such as a plastic or metal film. That is, the RFID card 10 can be made extremely thin and can be carried or mounted easily. For example, the RFID card 10 may be attached to a card to be strapped around the user's neck with a string. Alternatively, the RFID card 10 may be attached to the personal belongings with a seal or the like so that the RFID card 10 of this system is always carried. When the user can always carry the RFID card 10, information can be transmitted faster and with more reliability.

(A Structure of a Reader/Writer for Communication)

The reader/writer for communication 12 includes an antenna 1201; a high frequency circuit 1202 including a modulation circuit, a demodulation circuit, an encoding circuit, a transmitter, a frequency filter, and the like; a logic portion 1203; a memory portion 1204; a display portion 1205; and a communication port 1206.

The reader/writer for communication 12 includes the antenna 1201 to communicate with the RFID card 10 wirelessly. The antenna 1201 is connected to the high frequency circuit 1202. In the high frequency circuit 1202, a received wireless signal is demodulated and converted into an electric signal to transmit the signal to the logic portion 1203. In addition, in the high frequency circuit 1202, a signal from the logic portion 1203 is encoded and modulated to transmit the signal from the antenna 1201.

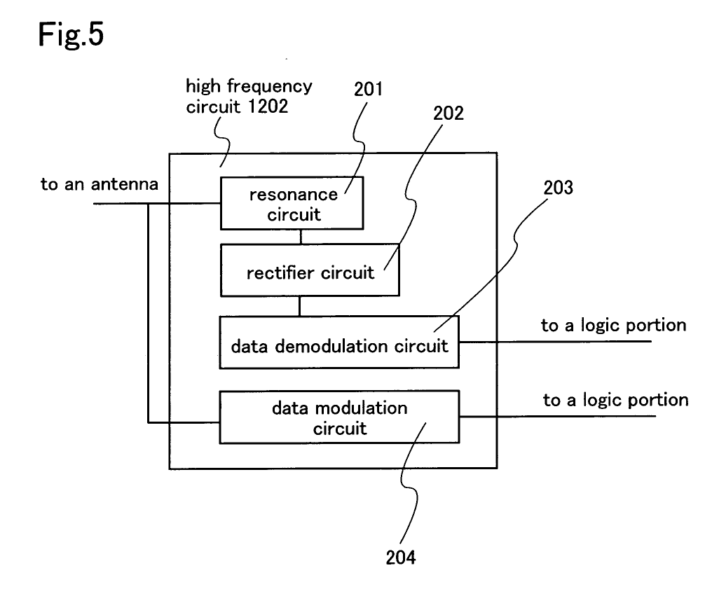

FIG. 5 shows a detail view of the high frequency circuit 1202. The high frequency circuit includes a resonance circuit 201 for converting an electromagnetic wave from the antenna 1001 (an antenna portion) into current or a voltage signal. The voltage signal generated in the resonance circuit 201 is transmitted to a rectifier circuit 202. In addition, a signal from the antenna 1201 is transmitted to a data demodulation circuit 203 and a command signal or the like is taken out to be transmitted to the logic portion. Information from the logic portion is converted by a data modulation circuit 204 and transmitted to the RFID card 10.

The logic portion 1203 includes an RFID command processing portion 1210 for processing a command relating to the RFID card 10, a memory control portion 1208 for processing a command to the memory portion 1204, and a command processing portion 1209 for processing a command from the host computer 14. The RFID command processing portion 1210 generates a command and a signal based on a communication standard in order to control communication with the RFID card 10. The command processing portion 1209 interprets a command from a high-order system and judges or controls an operation of the reader/writer for communication 12. The memory control portion 1208 is connected to the memory portion 1204 and when a command to access the memory portion 1204 is given, the memory control portion 1208 supplies a voltage for reading and writing information from and to the memory portion 1204 to a memory element of a specified address.

The memory portion 1204 includes individual-identifying information of the reader/writer for communication 12, application software for communicating with the RFID card 10, a database for replacing a command from the high-order system by an internal command, and the like. By providing the memory portion 1204 in the reader/writer for communication 12, a complicated processing can be performed in the reader/writer for communication 12 without using the host computer 14. Therefore, information can be transmitted even faster in the system.

The reader/writer for communication 12 has a communication port 1206 for transmitting and receiving data to and from an external high-order system (the host computer 14). The communication port 1206 is connected to the logic portion 1203. As a specific example of the communication port 1206, a USB port, a serial port, a port for wireless communication, and the like are given. The port allows the reader/writer for communication 12, to transmit and receive data to and from the host computer 14. In addition, a high-speed assessment of the situation and a complicated operation can be done by the host computer 14.

(A Structure of a Host Computer)

The host computer 14 has a central processing unit 1402 (CPU); a memory portion 1403 having a semiconductor memory, magnetic recording media, optical recording media, and the like; a communication port 1404 (such as a USB, a serial port, and a LAN (Local Area Network) port) for transmitting and receiving information to and from an external system; an inputting medium 1401 such as a key board, a pointing device, and an audio inputting device; and a display portion 1444. Various data such as individual-identifying information are stored in the memory portion 1403.

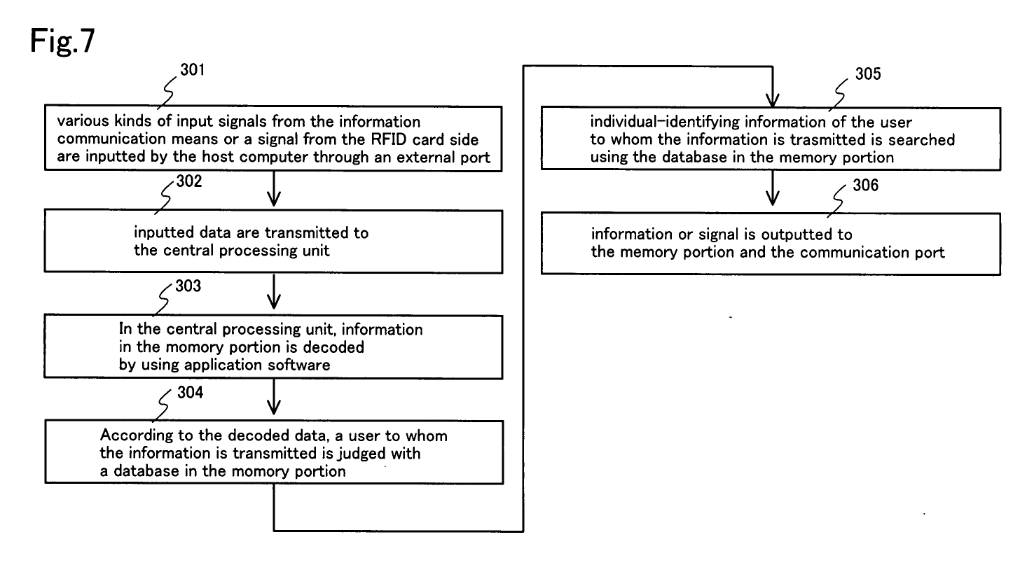

FIG. 7 shows an operation of the host computer 14. First, various kinds of input signals (such as an input signal of an alarm) from the information communication means 16 or a signal from the RFID card 10 side are inputted by the host computer 14 through an external port (a step 301). The inputted data are transmitted to the central processing unit 1402 (a step 302). In the central processing unit 1402, information in the memory portion 1403 is decoded by using application software (a step 303) and according to the decoded data, a user to whom the information is transmitted is judged with a database in the memory portion 1403 (a step 304). Then, individual-identifying information (number) of the user to whom the information is transmitted is searched using the database in the memory portion 1403 (a step 305). Thereafter, how to react to the inputted signal is judged. Next, data to be transmitted are formatted and information or a signal is outputted to the memory portion 1403 and the communication port 1404 (a step 306). Information is transmitted to the user through the host computer 14; therefore the user can get information immediately.

The memory portion 1403 includes the database which is necessary to operate the system and software to execute the system. The database in the memory portion 1403 has data for assigning individual-identifying information in the RFID card 10 to the owner. The database in the memory portion 1403 also has data for identifying the information inputted to the host computer 14, and the like. In addition, there is a case where the position of each RFID card 10 is recorded. In addition, the memory portion 1403 has data for holding communication record to the host computer 14, data for holding progress of a process after transmitting information, and the like. The information can be managed by being stored in the memory portion 1403 in the host computer 14. In addition, information query can be carried out quickly from the information communication means 16 connected to the host computer 14 therefore, information can be transmitted fast and a problem can be solved fast not only as an individual but also as a group.

(Information Communication Means)

The information communication means 16 includes a communication port for connecting to the host computer 14. The information communication means 16 is connected to the host computer 14 through a USB, a serial interface, a LAN, or the like. The information communication means 16 transmits information such as paging to the RFID card 10 through the host computer 14. In addition, the information communication means 16 receives data of the RFID card 10 through the host computer 14. By providing the information communication means 16, a command such as a paging command can be transmitted. Therefore, the host computer 14 can be informed of the event which needs an immediate response when the event occurs. In addition, the information communication means 16 can obtain information of the RFID card 10 by receiving information of the host computer 14. The information communication means 16 can collect and communicate information fast, thereby information can be transmitted fast.

### Embodiment Mode 2

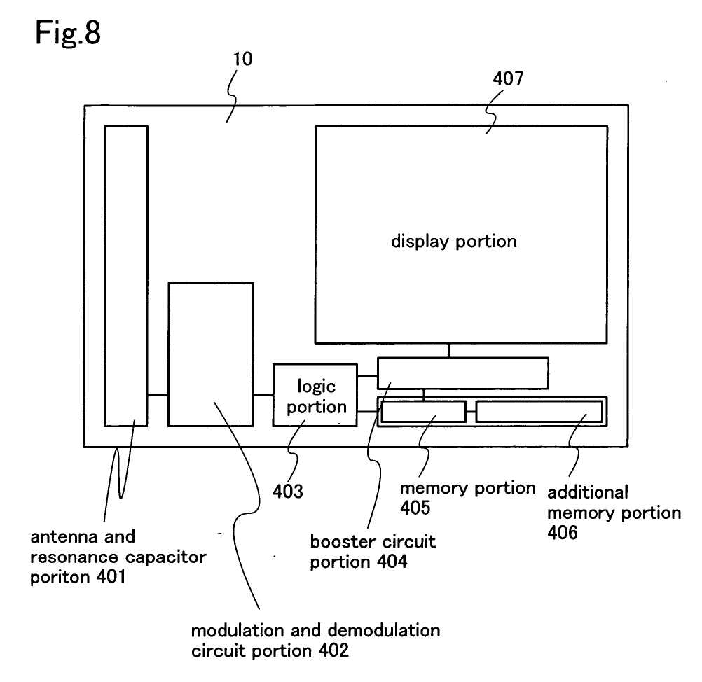

The RFID card 10 shown in FIG. 8 includes an antenna and resonance capacitor portion 401, a modulation and demodulation circuit portion 402, a logic portion 403, a booster circuit portion 404, a memory portion 405, an additional memory portion 406, and a display portion 407. The additional memory portion 406 stores information other than individual-identifying information. The memory portion 405 is a non-rewritable memory. On the other hand, the additional memory portion 406 is a rewritable memory. By providing the additional memory portion 406, information such as an operation record and a reception record can be stored in the RFID card 10. In addition, the use of the non-rewritable memory as a memory for storing individual-identifying information allows information to be read faster than in the case where a rewritable memory is used for storing individual-identifying information. Thus, the RFID card 10 can be used as a terminal device.

### Embodiment Mode 3

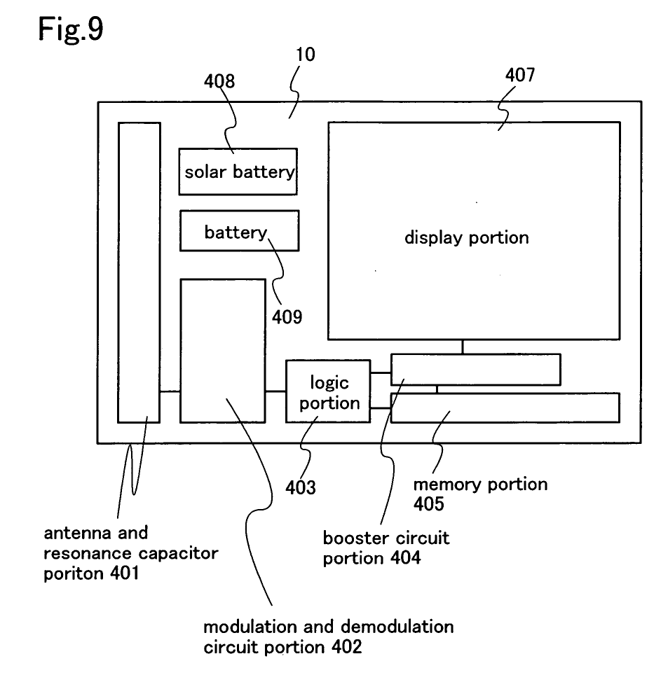

The RFID card 10 shown in FIG. 9 includes a battery 409 within the RFID card 10. By providing the battery 409 (in FIG. 9, mentioned as a battery), the RFID card 10 is driven in an active manner (in which a battery is provided in an RFID card and a circuit in the RFID card is driven by the battery), the communication distance can be extended and the RFID card 10 can operate in an area with poor reception. In addition, with the battery 409, the RFID card 10 is kept in working condition even when the RFID card 10 is temporarily outside of the area in which communication can be carried out, so that convenience of obtaining and checking information can be improved. As the battery 409, a film-shaped lithium ion battery, a film-shaped lithium ion polymer battery, a nickel-hydrogen battery, an organic radical battery, a proton polymer battery, a biofuel battery, or the like can be used. In addition, the battery 409 may be combined with a solar battery 408. Other components included in the RFID card 10 are the same as those described in Embodiment Mode 2.

### Embodiment Mode 4

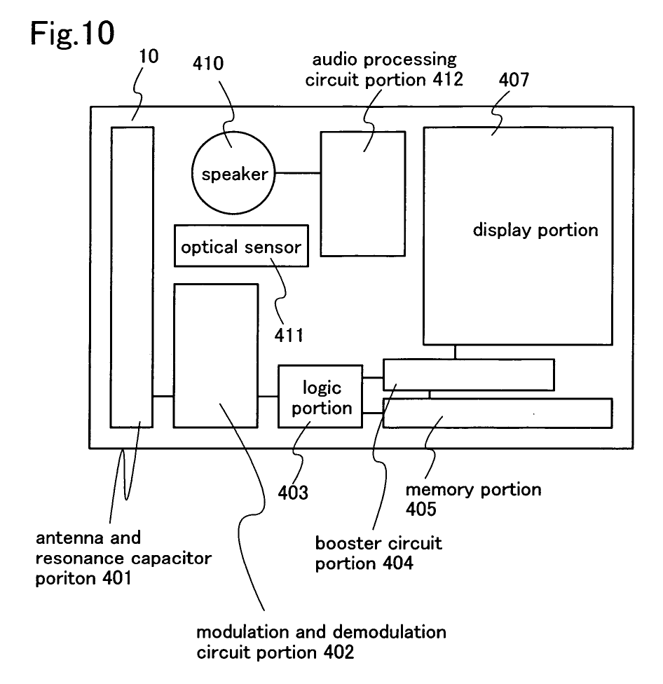

The RFID card 10 has the display portion 407 so that emergency information can be transmitted immediately. As shown in FIG. 10, the RFID card 10 may also have a speaker 410 and an audio processing circuit portion 412. When the information is given only by being displayed on the display portion 407, there is a possibility that the information is overlooked. When the information is given with sound to attract attention, there is less possibility that the information is overlooked and an immediate response to the information sent to the RFID card 10 can be made. Other components included in the RFID card 10 are the same as those described in Embodiment Mode 2.

### Embodiment Mode 5

As shown in FIG. 10, the RFID card 10 may have an optical sensor 411 for brightness control. The optical sensor 411 detects light in an environment where the terminal device is used. The terminal device controls the brightness of the display portion 407 according to the detected information. Therefore, power consumption of the display portion 407 can be reduced. In addition, the optical sensor 411 can also be used as an operation button. Other components included in the RFID card 10 are the same as those described in Embodiment Mode 2.

### Embodiment Mode 6

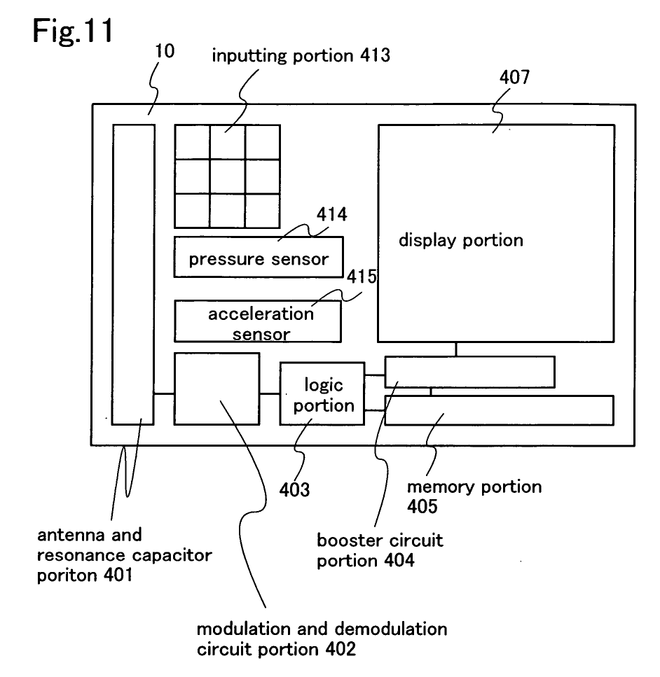

As shown in FIG. 11, an inputting portion 413 may be incorporated in the RFID card 10. A push button switch, a capacitance switch, or the like can be applied to the inputting portion 413. The inputting portion 413 allows the RFID card 10 to be used as a terminal device. In addition, by using the inputting portion 413 and the memory portion 405 in combination, a complicated operation such as browsing information in the memory portion 405 can be carried out. Other components included in the RFID card 10 are the same as those described in Embodiment Mode 2.

### Embodiment Mode 7

As shown in FIG. 11, a pressure sensor 414 may be incorporated in the RFID card 10. By using the pressure sensor 414 as an operation button, the operation button can be thinned. In addition, a manufacturing process can be simplified and the RFID card 10 can be inexpensively manufactured. In addition, the whole RFID card 10 including the operation button formed of the pressure sensor 414 can be coated with a coating material. Therefore, the reliability of a circuit in the RFID card 10 can be improved. Other components included in the RFID card 10 are the same as those described in Embodiment Mode 2.

### Embodiment Mode 8

As shown in FIG. 11, an acceleration sensor 415 may be incorporated in the RFID card 10. The acceleration sensor 415 is used as an operation button. For example, the RFID card 10 can be easily operated by lightly hitting the RFID card 10 against a table. In addition, the whole RFID card 10 including the operation button formed of the acceleration sensor 415 can be coated with a coating material. Therefore, the reliability of a circuit in the RFID card 10 can be improved.

### Embodiment Mode 9

The operation button which is operated by touching a screen (a touch panel) may be provided in the display portion 407 in the RFID card 10 shown in Embodiment Modes 1 to 8. In that case, the RFID card 10 can be made smaller since the display portion 407 can be used as the operation button. In addition, the operation item can be selected while watching the screen, therefore there is an advantage that the operation can be easier for the user.

### Embodiment Mode 10

The RFID card 10 shown in Embodiment Modes 1 to 9 can be used independently as an information terminal by receiving power supply from a reader/writer for communication. In that case, the RFID card 10 can be operated even when a command is not given to the RFID card 10. For example, the communicated information can be checked when there is enough time, time can be used efficiently.

### Embodiment Mode 11

As shown in FIG. 1, the reader/writer for communication 12 may include the display portion 1205. The reader/writer can mount the display portion with a large screen; therefore, a larger amount of information with more details than the display portion 407 of the RFID card 10 can be displayed.

### Embodiment Mode 12

As shown in FIG. 1, the reader/writer for communication 12 may include an inputting portion 1207. The inputting portion 1207 can be formed by a pointing device, a push switch, a pen inputting device combined with the display portion 1205, or the like. Therefore, when the user of the RFID card 10 receives information, the user can inform the host computer whether he/she has responded to the information. In addition, the progress of solving the problem can be given to a third person.

### Embodiment Mode 13

The access means to a telephone line or the like may be combined to the reader/writer for communication 12, thereby communication can be made by telephone or the like. The given information can be checked, so that information can be transmitted with more reliability.

### Embodiment Mode 14

As an example of the information communication means connected to the host computer 14, a telephone line can be given. When an event of an extreme emergency or an abnormal situation occurs, the information can be transmitted to the RFID card 10 usually. However, when there is no response from the RFID card 10 or no measures are taken though there is a response, the telephone line can transmit information using a different means from the RFID card 10. When the owner of the RFID card 10 is not in the communication area of the reader/writer for communication, information can be transmitted immediately. When the owner of the RFID card 10 is in the communication area of the reader/writer for communication though no measures are taken, it is possible to hasten the owner to take measures by telephone.

### Embodiment Mode 15

As another example of the information communication means connected to the host computer 14, an alarm system can be given. The role of the alarm system is described. The alarm system can detect the event which needs an immediate response when the event occurs and transmit a signal about the event to the host computer 14. The alarm system can also cancel an issued alarm. Besides, the host computer 14 can receive an alarm cancel signal to cancel an alarm. Since it is possible to cancel the alarm with the host computer 14, the situation can be controlled without visiting the place where the alarm is issued, which is also effective in the case where the multifunction of an alarm device occurs and it is not necessary to visit the place where the alarm is issued. In addition, various kinds of data other than the data on the alarm, such as a place where the alarm is issued are sent to the host computer 14. With the data other than the alarm, the owner of the RFID card 10 can find out the abnormal situation to take appropriate measures.

### Embodiment Mode 16

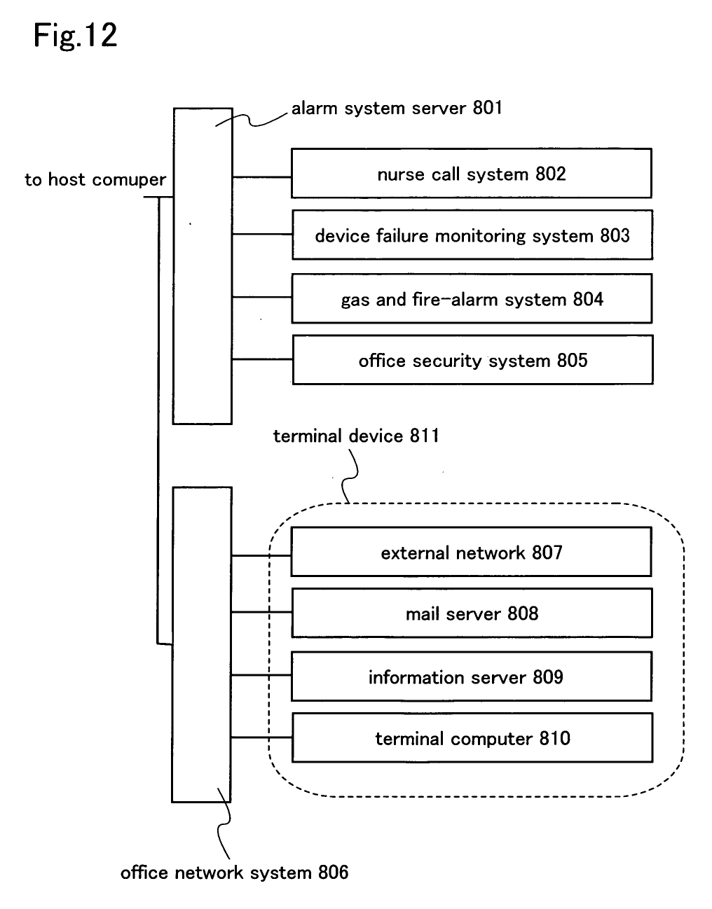

The structure of the alarm system described in Embodiment Mode 15 is described. FIG. 12 shows the alarm system. The alarm system is a system which discovers an emergency situation, and issues an alarm. The alarm system has an alarm system server 801 and an alarm detection device. The alarm system server 801 is connected to the alarm detection device through a leased line. In addition, the alarm system server 801 is connected to the host computer 14 through a USB, a serial interface, a LAN, or the like. The alarm system server 801 recognizes the kind of the alarm, and informs the host computer 14 that the alarm is issued. By providing the alarm system server 801, information of the alarm and the alarm device can be collectively managed.

The alarm detection device detects various kinds of abnormal situations with a sensor and transmits the information thereof to the alarm system server 801. By using a sensor machine of as the sensor of the alarm detection device, the environment can always be monitored. In addition, by using the sensor machine, an alarm signal can be immediately issued when the abnormal situation occurs. An example of the alarm detection device is described with reference to FIG. 12.

A nurse call system 802 to receive contact from patients and their family of the patient is described. When the nurse call system 802 operates, the information is transmitted to the host computer 14 through the alarm system server 801. Then, a contact is made to the RFID card 10 of the patient's doctor registered in the database in the host computer 14 or the nearest doctor. In a hospital, the use of a portable phone is prohibited in principle in consideration of its effect on medical equipment. In such a situation, information which requires an immediate response such as a sudden change in the patient's condition can be transmitted immediately.

A device failure monitoring system 803 is described. When a problem occurs in a device or experiment device in a production line in a factory, the device failure monitoring system 803 transmits a signal to the host computer 14 through the alarm system server 801. When the person in charge is not around the device, the database of the host computer 14 is searched and a paging command is outputted to the RFID card 10 of the person in charge to be communicated with him/her.

A gas and fire-alarm system 804 which discovers a gas leak and a fire is described. When a gas leak or a fire happens, a sensor detects that. The information thereof is transmitted from the sensor through the alarm system server 801 to the host computer 14 so that information can be provided to the person in charge and an evacuation order is given to the RFID card 10. As an example of the same kind, an earthquake and flood sensor can be given. When an earthquake occurs, a signal is transmitted to the host computer 14. In conjunction with other alarm systems, the earthquake and flood sensor informs the host computer 14 of the extent of the damage. Information can be provided to the person in charge in the event of emergency and information or an evacuation order can be given to other users in the building with the RFID cards 10.

An office security system 805 for monitoring the security of a building is described. When suspicious individual enters the building, he/she is monitored with an infrared radiation sensor or a camera, and a signal is transmitted to the alarm system server 801. When the signal is sent to the host computer from the alarm system server 801, the database in the host computer 14 is searched to make contact with a user in the building or a person in charge. It is also possible to call an alarm company. Thus, the user can recognize an abnormal situation immediately to secure personal security or to prevent theft.

### Embodiment Mode 17

The alarm system described in Embodiment Mode 16 may have a camera or a microphone in addition to the alarm detection device. When an abnormal situation occurs, visual data or the like are important to decide how to respond to the situation next. By providing a camera or a microphone as well as with an alarm, data on the situation with more detail can be sent to the host computer 14 and the owner of the RFID card 10, and immediate and appropriate measures can be taken to the abnormal situation.

### Embodiment Mode 18

As another example of the information communication means connected to the host computer 14, an office network system 806 can be given (see FIG. 12). The office network system 806 is connected to the host computer 14 through a LAN. In addition, the office network system is also connected to a terminal device 811 through a LAN. When an immediate contact is needed due to factors other than the alarm system, a command for paging can be transmitted to the host computer 14 through the network. In addition, information of operating information of the system and a remote control command of the host computer 14 are transmitted through the network. By using the office network system, a command for paging can be transmitted from the plurality of places. Moreover, information of the operating condition of the system can be checked and a remote control of the host computer 14 can be operated from any terminal device connected to the office network. Therefore, many people can check whether measures to an order for paging or the like are taken or not. Note that the office network system is connected to an external network 807; therefore, signals from outside the company can be received.

An operation of the office network system 806 is described. When a signal from the host computer 14 is outputted to an office network line, the signal is transmitted to the terminal device 811 which is connected to the office network to be outputted therefrom. On the other hand, when the signal for paging or a control order is sent from the terminal device 811, the signal is transmitted to the host computer 14 through the office network system. The office network line can utilize an office LAN system, therefore the system can be inexpensively introduced.

### Embodiment Mode 19

As an example of the terminal device connected to the office network system 806, a mail server 808 can be given. The role of the mail server 808 is described. When an email is received, the level of importance of the email is distinguished by the mail server 808. The mail server 808 informs the owner of the RFID card 10 of the reception of an email with high importance. The owner can know that he/she receives the email with high importance is received without booting up email software or a personal computer. Thus, the owner of the RFID card 10 can notice the reception of a mail earlier.

The mail server 808 has a computer for receiving a mail, and a management program for transmission and reception of an email. The mail server is connected to the office network system through a LAN port. When an email is received, information on the email is transmitted to the host computer 14 through a LAN. It is possible to transmit the message of the email as well as information on the reception of the mail.

The mail server 808 can also transmit information on the importance level which is applied to the mail to the host computer 14. By additionally applying the information on the importance level of the email, a command sent to the RFID card 10 can be changed by the host computer 14.

### Embodiment Mode 20

As an example of the terminal device connected to the office network system 806, an information server 809 can be given (see FIG. 12). The role of the information server 809 is described. When important information is submitted to the information server 809, the user of the RFID card 10 is informed. The owner can know the reception of the important information without booting up browsing software for information on the server (such as a WEB browser) or a personal computer.

The information server 809 has a computer for receiving information on a message board and a program for controlling the information server. The information server is connected to the office network system 806 through a LAN port. When information is received through the office network system 806, the information server 809 informs the host computer 14 of the reception of the information through a LAN. It is possible to transmit content of the information as well as the reception of the information.

### Embodiment Mode 21

As an example of the terminal device connected to the office network system, a terminal computer 810 can be given (see FIG. 12). The terminal computer 810 is connected to the office network system through a LAN. The terminal computer transmits information for paging to the owner of the RFID card 10. By providing the terminal computer 810, a command for paging or the like can be transmitted by a person who operates the terminal computer even in the case of an event which cannot be detected by an alarm device or a computer system. In addition, it is possible to get access to information in the host computer 14 or to get access to the host computer 14 to check the operating condition of the system or to control the system. Thus, a third person can check if an immediate response is taken in an emergency situation.

The terminal computer 810 has a display, a CPU, a keyboard, a hard disk, a memory, and a communication port to communicate with an external device. As an example of the communication port, a USB port, a serial port, a LAN port, or the like can be given. The terminal computer is connected to the office network system 806 through a LAN port. The terminal computer 810 can transmit information such as for paging to the office network system by a person or a computer. In addition, it is possible to check the operating condition of the system with the host computer 14, or conduct maintenance of the system.

### Embodiment Mode 22

Usage of the terminal computer 810 shown in FIG. 12 is described with an example. When the user of the terminal computer has a visitor, or receives a command for paging, a phone call, a fax, disaster information, or the like, the user transmits a command to the host computer 14 to call a specific RFID card 10 by using the terminal computer. Alternatively, the user transmits character data on the information so that the information can be transmitted fast to the owner of the RFID card 10.

With the terminal computer 810, the database in the host computer 14 can be searched to see the position of the RFID card 10. Measures such as calling the nearest internal phone can be taken as well as sending information to the RFID card 10.

Whether there is a response or not is checked. Whether the RFID cared 10 is in the area in which a radio wave of reader/writer for communication can be received or not can be checked with the host computer 14. It is possible to make contact with the owner of the RFID card 10 by a method other than transmitting information to the RFID card 10. Whether measures are taken to a command for paging or not can be checked. When there are no measures, another method can be tried to call the owner of the RFID card 10 or another person can be called instead so that the problem can be solved immediately as a group.

Maintenance of the system is conducted. The operating condition of the system can be checked or a database can be updated by the terminal computer.

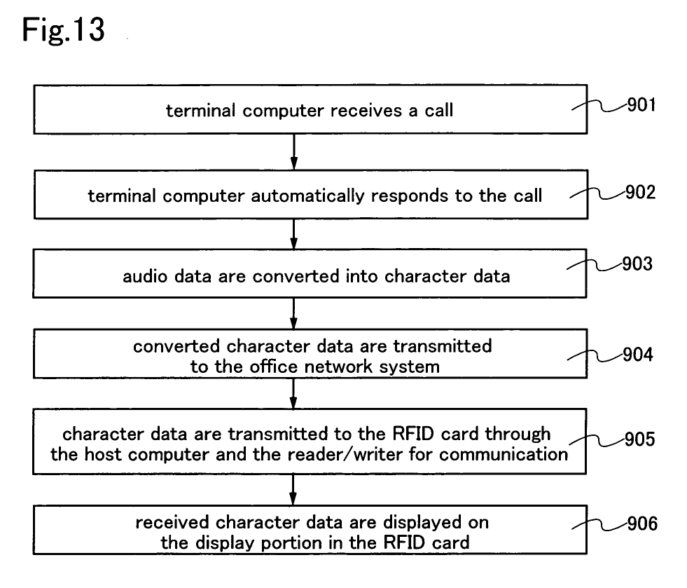

An operation of receiving a call is described with reference to FIG. 13. The terminal computer 810 is connected to a telephone line. The terminal computer 810 receives a call (a step 901). The terminal computer 810 automatically responds to the call (a step 902). Then, audio data are converted into character data (a step 903). The converted character data are transmitted to the office network system 806 (a step 904). The character data are transmitted to the RFID card 10 through the host computer 14 and the reader/writer for communication 12 (a step 905). The received character data are displayed on the display portion 1005 in the RFID card 10 (a step 906).

By combining this system with schedule software installed to the terminal computer, information such as where and what kind of a meeting is going to be held next can be automatically transmitted to the RFID card 10. Thus, the schedule can be managed without using a large terminal such as a personal computer. In addition, by combining this system with the office network system, change in the schedule can be supported.

### Embodiment Mode 23

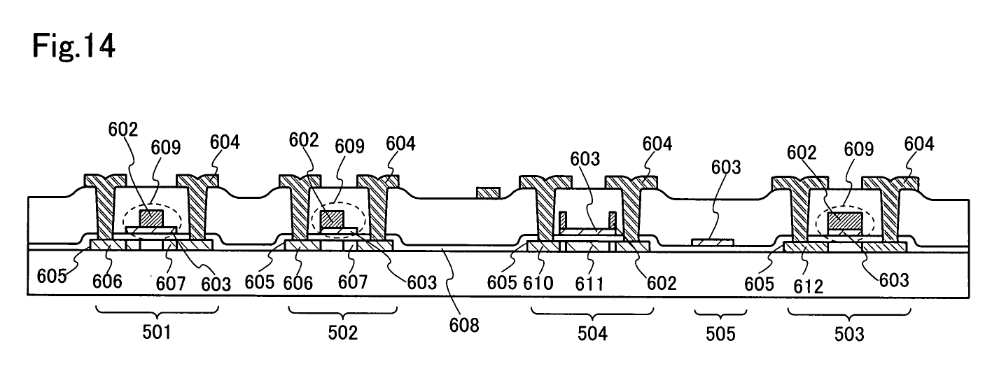

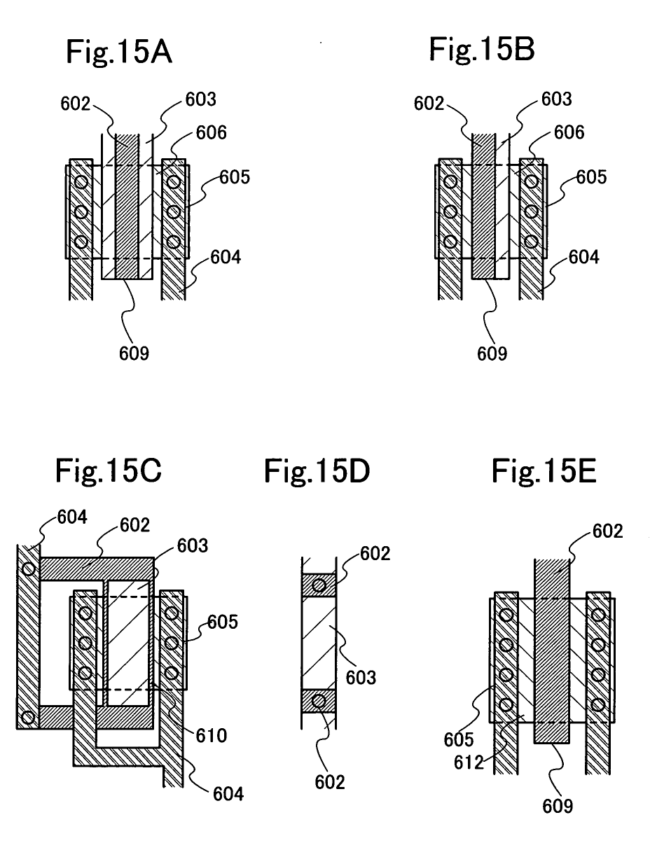

A circuit in the RFID card 10 (the display portion, the memory portion, the logic potion, or the like) can be formed with a transistor. As the transistor, a thin film transistor (a TFT) as well as a MOS transistor formed over a single crystalline substrate can be used. FIG. 14 shows a cross-sectional structure of a transistor in those circuits. In FIG. 14, an n-channel transistor 501, an n-channel transistor 502, a capacitor 504, a resistance element 505, and a p-channel transistor 503 are shown. Each transistor has a semiconductor layer 605, a gate insulating layer 608, and a gate electrode 609. The gate electrode 609 has a stacked layer structure of a first conductive layer 603 and a second conductive layer 602. FIGS. 15A to 15E are top views for showing the transistor, the capacitor, and the resistance element shown in FIG. 14 and can also be referred to.

In FIG. 14, the n-channel transistor 501 has the semiconductor layer 605 in the channel length direction (the flowing direction of carriers) that includes impurity regions 606 forming source and drain regions each of which is connected to a wire 604 and impurity regions 607 each with a lower concentration than that of the impurity regions 606. The impurity region 607 is also called a lightly doped drain (LDD). In the case of the n-channel transistor 501, the impurity regions 606 and 607 are doped with an impurity imparting n-type conductivity such as phosphorus. The LDD is formed so as to prevent hot electron deterioration and a short channel effect.

As shown in FIG. 15A, in the gate electrode 609 of the n-channel transistor 501, the first conductive layer 603 is formed so as to extend on both sides of the second conductive layer 602. In that case, the thickness of the first conductive layer 603 is thinner than that of the second conductive layer. The thickness of the first conductive layer 603 is set so as to transmit ion species accelerated in an electric filed of 10 to 100 kV. The impurity region 607 is formed so as to overlap the first conductive layer 603 of the gate electrode 609. That is, an LDD region which overlaps the gate electrode 609 is formed. In this structure, the impurity region 607 is formed in a self alignment manner by adding an impurity imparting one conductivity type through the first layer 603 using the second conductive layer 602 as a mask. That is, the LDD which overlaps the gate electrode is formed in a self alignment manner.

A transistor having LDDs on both sides of the channel formation region is used as a TFT in the rectifier circuit 102 such as in FIG. 2 or a transistor in a transmission gate (also referred to as an analog switch) used in a logical circuit. In the TFT, positive and negative voltages are applied to the source and the drain electrodes, therefore, LDDs are preferably formed on both sides of the channel formation region.

In FIG. 14, the n-channel transistor 502 has the semiconductor layer 605 that includes the impurity regions 606 forming source and drain regions and the impurity region 607 with a lower concentration than that of the impurity regions 606. The impurity region 607 is formed on one side of the channel formation region so as to be in contact with one of the impurity regions 606. As shown in FIG. 15B, in the gate electrode 609 of the n-channel transistor 502, the first conductive layer 603 is formed so as to extend on one side of the second conductive layer 602. In such a structure also, the LDD can be formed in a self alignment manner by adding an impurity imparting one conductivity type through the first layer 603 using the second conductive layer 602 as a mask.

A transistor having an LDD on one side of the channel formation region may be used as a transistor in which either a positive voltage or a negative voltage is applied between source and drain electrodes. Specifically, the transistor may be applied to a transistor forming a logical gate such as an inverter circuit, a NAND circuit, a NOR circuit, and a latch circuit, a transistor forming an analog circuit such as a sense amplifier, a constant voltage generating circuit, and a VCO.

As shown in FIG. 14, the capacitor 504 is formed so that the gate insulating layer 608 is interposed between the first conductive layer 603 and the semiconductor layer 605. The semiconductor layer 605 in the capacitor 504 has the impurity regions 610 and 611. The impurity region 611 is formed in the semiconductor layer 605 so as to overlap the first conductive layer 603. The impurity region 610 is connected to the wire 604. Since the impurity region 611 is doped with an impurity of one conductivity type through the first conductive layer 603, the concentrations of the impurities contained in the impurity regions 610 and 611 may be the same or different. In any case, in the capacitor 504, the semiconductor layer 605 serves as an electrode; therefore the semiconductor layer 605 is preferably doped with an impurity imparting one conductivity type to lower the resistance thereof. In addition, as shown in FIG. 15C, by using the second conductive layer 602 as an auxiliary electrode, the first conductive layer 603 can sufficiently operate as an electrode. Thus, by combining the first conductive layer 603 and the second conductive layer 602 to form a multiple electrode structure, the capacitor 504 can be formed in a self alignment manner.

The capacitor 504 is used as storage capacitance of the rectifier circuit 102 or resonance capacitance of the resonance circuit 101. Specifically, the resonance capacitance is required to function as capacitance regardless of whether a voltage between the two terminals of the capacitor is positive or negative, since both positive voltage and negative voltage are applied between the two terminals of the capacitor.

In FIG. 14, the resistance element 505 is formed using the first conductive layer 603. The first conductive layer 603 is formed so as to have a thickness of 30 to 150 nm, the width or the thickness of the semiconductor layer 603 can be appropriately set to form the resistance element (see FIG. 15D).

The resistance element is used as a resistance load or the like included in the data modulation circuit 105 in FIG. 2. Alternatively, the resistance element may be used as a load in the case where current is controlled by a VCO or the like. The resistance element may be formed with a semiconductor layer containing an impurity element at a high concentration, a metal layer with a thin thickness, or the like. A metal layer is preferable to a semiconductor layer because the resistance value of the metal layer depends on a film thickness and a film property while the resistance value of the semiconductor layer depends of a film thickness, a film property, a concentration of an impurity, an activation ratio, and the like; therefore variation in the resistance value of the metal layer is smaller than that of the semiconductor layer.

In FIG. 14, the p-channel transistor 503 has an impurity region 612 in the semiconductor layer 503. The impurity region 612 forms source and drain regions each of which is connected to the wire 604. The gate electrode 609 has a structure in which the first conductive layer 603 and the second conductive layer 602 overlap each other (see FIG. 15E). The p-channel transistor 503 is a transistor having a single drain structure in which an LDD is not formed. When the p-channel transistor 503 is formed, the impurity region 612 is doped with an impurity for imparting p-type conductivity, such as boron. On the other hand, when the impurity region 612 is doped with phosphorus, an n-channel transistor having a single drain structure can be formed.

The semiconductor layer 605 which serves as an active layer in the transistor can be formed with a crystallized semiconductor. For crystallization, a crystallization method with a heat treatment may be combined with a crystallization method with laser beam irradiation of a continuous wave laser or laser with a repetition rate of 10 MHz or more. In any case, by irradiating the semiconductor layer with a laser beam of the continuous wave laser or the laser with a repetition rate of 10 MHz or more, a surface of a crystallized semiconductor layer can be planarized. Thus, a gate insulating film can be thinned and resistance thereof to pressure can be improved.

Then, the gate insulating layer 608 is formed to cover the semiconductor layer 605. The gate insulating layer 608 may be formed by oxidizing or nitriding the surface of the semiconductor layer 605 with a treatment using high density plasma which is excited by a microwave, has an electron temperature of 2 eV or less, an ion energy of 5 eV or less, and an electron density of approximately 10¹¹ to 10¹³/cm³. For example, the gate insulating layer 608 is formed by a plasma treatment with a mixed gas of a rare gas such as He, Ar, Kr, and Xe, and oxygen, nitrogen oxide (NO₂), ammonia, nitrogen, hydrogen, and the like. In that case, if plasma is excited by introduction of a microwave, plasma with a low electron temperature and high density can be generated. With oxygen radical (which may include OH radical) or nitrogen radical (which may include NH radical) generated by high density plasma, oxidizing or nitriding of the surface of the semiconductor film can be conducted.

By such a treatment using high density plasma, an insulating film is formed over surface of the semiconductor layer 605 to have a thickness of 1 to 20 nm, typically, 5 to 10 nm. Here, the reaction is a solid phase reaction; therefore, an interface state density between the insulating film and the semiconductor layer 605 can be extremely low. In addition, with such a high density plasma treatment, oxidizing (or nitriding) treatment can be directly conducted to the semiconductor film (crystalline silicon or polycrystalline silicon), variations in the thickness of the insulating film can be extremely small ideally. In addition, oxidation in crystalline silicon grain boundary is not promoted much; therefore, a favorable state can be realized. That is, since solid phase oxidation of the surface of the semiconductor layer 605 is caused by a high density plasma treatment, oxidation in crystalline silicon grain boundary is prevented from being exceeded; therefore, an insulating film with improved planarity and a low interface state density can be formed.

The gate insulating film may be only an insulating film which is formed by a high density plasma treatment, or another insulating film may be stacked thereover by a CVD method utilizing plasma or thermal reaction using silicon oxide, silicon oxynitride, silicon nitride, or the like. In any case, when transistors include an insulating film formed by high density plasma as a part or whole of a gate insulating film, variation in characteristics can be reduced.

The semiconductor layer 605 which is obtained by crystallizing a semiconductor film by laser beam irradiation of a continuous wave laser or a laser with a repetition rate of 10 MHz or more while scanning in one direction has a characteristic that crystal thereof grows in the scanning direction of the beam. Therefore, a transistor is placed so that the scanning direction is the same as the channel length direction (the flowing direction of carriers in a channel forming region), and then the foregoing gate insulating layer is combined, thereby realizing a transistor (TFT) with small variations in characteristics and a high electron field-effect mobility.

As described with reference to FIGS. 14 and 15A to 15E, an element with various kinds of structures can be formed by combining conductive layers having different film thicknesses. A region in which only the first conductive layer is formed and a region in which the first and the second conductive layers are stacked can be formed by using a photo mask or a reticle which is formed by a diffraction grating pattern or a an auxiliary pattern which has a semipermeable membrane with a function of reducing light intensity. That is, in a photolithography process, when a photoresist is exposed to light, the amount of light which transmits a photo mask is adjusted so that a developed resist mask has a varied thickness. In that case, a slit which is equal to or lower than the theoretical resolution limitation may be formed in the photo mask or the reticle so that a resist having the foregoing complicated shape is formed. Alternatively, a mask pattern formed by a photoresist material may be changed in the shape by being baked at about 200° C. after development.

In addition, by using a photo mask or a reticle which is formed by a diffraction grating pattern or an auxiliary pattern which has a semipermeable membrane with a function of reducing light intensity, the region where only the first conductive layer is formed and a region where the first conductive layer and the second conductive layer are stacked can be continuously formed. As shown in FIG. 15A, a region in which only the first conductive layer is formed can be selectively formed over the semiconductor layer. Such a region is effective over the semiconductor layer but is not necessary in other regions (a wire region connected to the gate electrode). By using the photo mask or the reticle, a region in which only the first conducive region is not formed in the wire region; therefore, wire density can be substantially increased.

In FIGS. 14 and 15A to 15E, the first conductive layer is formed from a high melting metal such as tungsten (W), chromium (Cr), tantalum (Ta), tantalum nitride (TaN), or molybdenum (Mo); or an alloy or a compound mainly containing a high melting metal to have a thickness of 30 to 50 nm. The second conductive layer is formed from a high melting metal such as tungsten (W), chromium (Cr), tantalum (Ta), tantalum nitride (TaN), or molybdenum (Mo); or an alloy or a compound mainly containing a high melting metal to have a thickness of 300 to 600 nm. For example, the first conductive layer and the second conductive layer are formed from different conductive materials so that the etching rates are different from each other in a subsequent etching step. For example, the first conductive layer can be formed from TaN with the second layer formed from a tungsten film.

In this embodiment mode, a transistor, a capacitor, and a resistance element each of which has a different electrode structure can be formed in one pattern forming step by using a photo mask or a reticle which is formed by a diffraction grating pattern or an auxiliary pattern which has a semipermeable membrane with a function of reducing light intensity. Therefore, elements with different structures can be formed without increasing the number of steps and can be integrated according to characteristics of the circuit.

### Embodiment Mode 24

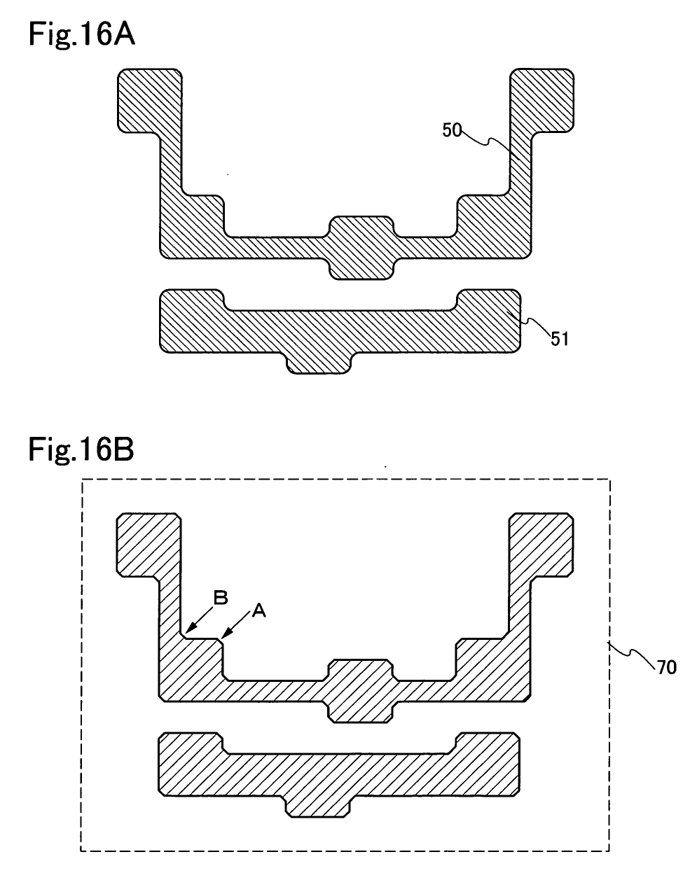

An example in which a static RAM (SRAM) is formed as a component of a terminal device (RFID card) is explained with reference to FIGS. 16A, 16B, 17A, 17B, 18A, and 18B.

Semiconductor layers 50 and 51 shown in FIG. 16A are preferably formed from silicon or a crystalline semiconductor containing silicon. For example, a polycrystalline silicon or single crystalline silicon which is formed by crystallizing a silicon film by laser annealing or the like is applied. Besides, a metal oxide semiconductor, amorphous silicon, or an organic semiconductor which shows semiconductor characteristics can be applied.

In any case, a semiconductor layer which is formed first is formed over the entire surface or a potion (a region which is larger than a region which is specified to be a semiconductor region in a transistor) of a substrate having an insulating surface. Then, a mask pattern is formed over the semiconductor layer by photolithography. The semiconductor layer is etched using the mask pattern to form predetermined island-shaped semiconductor layers 50 and 51 including source and drain regions and a channel formation region of a TFT. The semiconductor layers 50 and 51 are formed so as to have an appropriate layout.

The photo mask for forming the semiconductor layers 50 and 51 shown in FIG. 16A has a mask pattern 70 shown in FIG. 16B. The mask pattern 70 differs depending on whether a resist used in a photolithography step is a positive type or a negative type. When a positive type resist is used, the mask pattern 70 shown in FIG. 16B is formed as a light shielding portion. The mask pattern 70 has a polygon shape in which a top A is removed. In addition, in an inner side of a corner part B, the corner part bends a plurality of times so as not to make a right angle. That is, in this photo mask pattern, the corner of the corner part is removed.

The shape of the mask pattern 70 shown in FIG. 16B is reflected in the semiconductor layers 50 and 51 shown in FIG. 16A. In that case, the shape which is similar to the mask pattern 70 may be transcribed. Alternatively, the shape may be transcribed so that the corner in the corner part of the transcribed pattern has a rounder shape than the mask pattern 70. That is, a round part where the pattern shape is smoother than the mask pattern 70 may be provided.

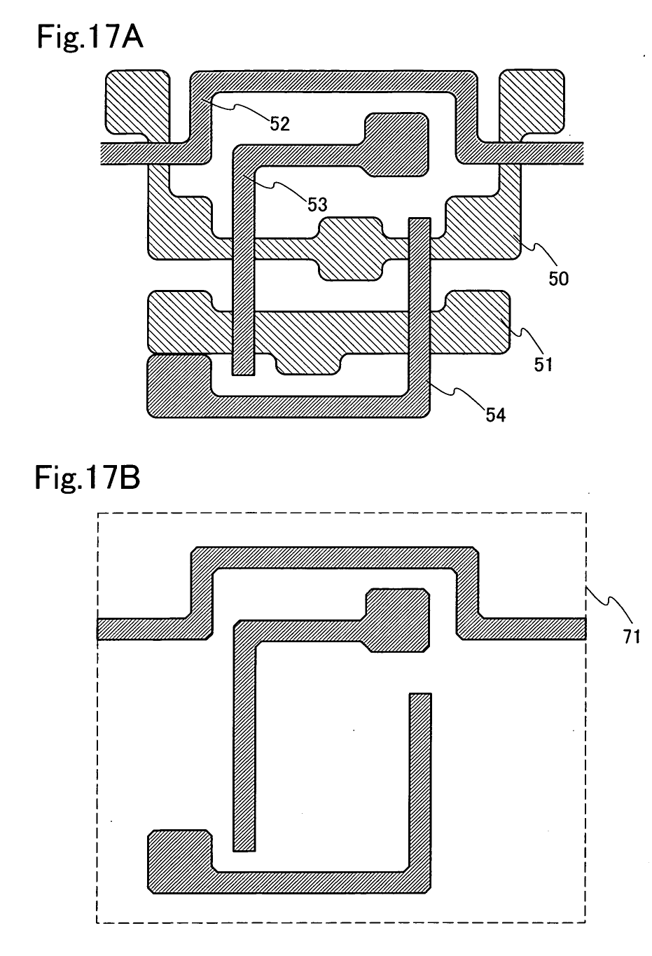

An insulating layer including silicon oxide or silicon nitride in at least one portion thereof is formed over the semiconductor layers 50 and 51. One purpose of forming the insulating layer is to function as a gate insulating layer. As shown in FIG. 17A, gate wires 52 to 54 are formed to overlap the semiconductor layer partially. The gate wire 52 is formed corresponding to the semiconductor layer 50 while the gate wire 53 is formed corresponding to the semiconductor layers 50 and 51. Besides, the gate wire 54 is formed corresponding to the semiconductor layers 50 and 51. The gate wire is formed by forming a metal layer or a semiconductor layer having high conductivity, and a shape of the gate wire is formed by photolithography over the semiconductor layer.

A photo mask used for forming the gate wire has a mask pattern 71 shown in FIG. 17B. In the mask pattern 71, a corner of a corner part is removed by a length of one-fifth to half the width of the wire. The shape of the mask pattern 71 shown in FIG. 17B is reflected to the gate wires 52 to 54 shown in FIG. 17A. In that case, the shape which is similar to the mask pattern 71 may be transcribed. Alternatively, the shape may be transcribed so that the corner of the corner part in the gate wires 52 to 54 has a rounder shape than the mask pattern 71. That is, a round part where the pattern shape is smoother than the mask pattern 71 may be provided in the gate wires 52 to 54. In an outer side of the corner part in the gate wires 52 to 54, generation of fine powder due to abnormal electrical discharge can be suppressed when dry etching by plasma is conducted. In addition, even if fine powder is attached to the substrate, an inner side of the corner part makes it possible to wash away the fine powder when cleaning without retaining washing liquids in the corner portion in the wire pattern.

An interlayer insulating layer is formed after forming the gate wires 52 to 54. The interlayer insulating layer is formed from an inorganic insulating material such as silicon oxide or an organic insulating material such as polyimide or an acryl resin. An insulating layer such as silicon nitride or silicon oxynitride may be formed between the interlayer insulating layer and the gate wires 52 to 54. In addition, an insulating layer such as silicon nitride or silicon oxynitride may also be formed over the interlayer insulating layer. The insulating layer prevents contamination of the semiconductor layer and the gate insulating layer due to an impurity which is not favorable to a TFT, such as exogenous metal ion and moisture.

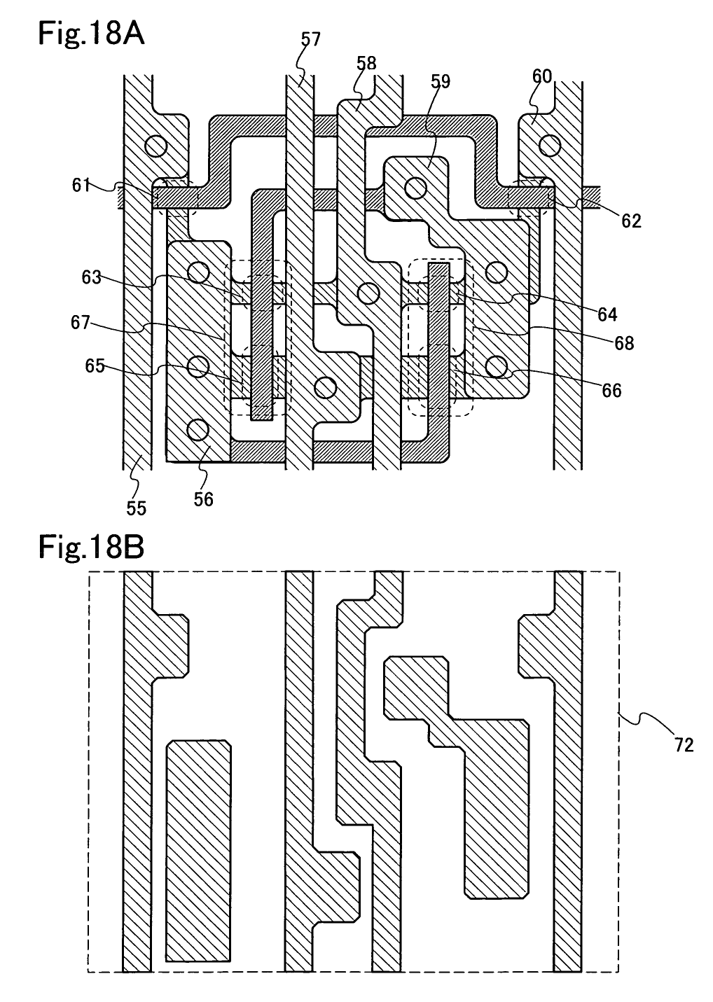

In the interlayer insulating layer, an opening is formed in a predetermined position. For example, the opening is formed corresponding to the gate wire and the semiconductor layer placed blow. A wire layer formed of a single layer or a plurality of layers of metal or a metal compound is etched into a predetermined pattern with a mask pattern formed by photolithography. Then, as shown in FIG. 18A, wires 56 to 60 are formed to overlap the semiconductor layer partially. The wire connects specific elements. The wire connecting an element to another element is not straight. The wire bends due to restriction of the layout. In addition, the width of the wire changes in a contact part or another region. In the contact part, the width of the wire is widened in a part of the contact part where the contact hole is equal to or wider than the width of the wire.

A photo mask used for forming the wires 55 to 60 has a mask pattern 72 shown in FIG. 18B. In this case also, a corner of a corner part in the mask pattern is removed by a length of one-fifth to half the width of the wire so as to make a round corner part. With such a shape, generation of fine powder due to abnormal electrical discharge can be suppressed when dry etching by plasma is conducted. In addition, even if fine powder is attached to the substrate, an inner side of the corner part makes it possible to wash away the fine powder when cleaning without retaining washing liquid in the corner portion of the wire pattern. As a result, there is an effect that yield can be improved. Thus is also advantageous that when many parallel wires are provided over the substrate, fine powder attached to the substrate can be easily washed away. In addition, the round corner part of the wire can be expected to allow electrical conduction.

In FIG. 18A, n-channel transistors 61 to 64 and p-channel transistors 65 and 66 are formed. The n-channel transistor 63 and the p-channel transistor 65 form an inverter 67 and the n-channel transistor 64 and the p-channel transistor 66 form an inverter 68. A circuit including these six transistors forms an SRAM. An insulating layer such as silicon nitride and silicon oxide may be formed over the transistors.

This application is based on Japanese Patent Application serial no. 2005-158229 filed in Japan Patent Office on May, 30, in 2005, the entire contents of which are hereby incorporated by reference.

What is claimed is:

1. A terminal device comprising:
an antenna to transmit and receive a wireless signal;
a high frequency circuit operationally connected to the antenna;
a logic portion to which an output from the high frequency circuit is inputted;
a memory portion to store an output from the logic portion; and
a display portion to which an output from the logic portion is inputted.

2. A terminal device comprising:
an antenna to transmit and receive a wireless signal;
a high frequency circuit operationally connected to the antenna;
a logic portion to which an output from the high frequency circuit is inputted;
a memory portion to store an output from the logic portion;
a display portion to which an output from the logic portion is inputted; and
an optical sensor for detecting an amount of external light and controlling a brightness of the display portion according to the amount of external light which is detected.

3. The terminal device according to claim 1, wherein the memory portion has a rewritable memory portion and a non-rewritable memory portion.

4. The terminal device according to claim 2, wherein the memory portion has a rewritable memory portion and a non-rewritable memory portion.

5. The terminal device according to claim 1,
wherein the memory portion has a rewritable memory portion and a non-rewritable memory portion,
wherein the non-rewritable memory portion is capable of storing information in advance, and
wherein the rewritable memory portion is capable of writing and reading information from the wireless signal.

6. The terminal device according to claim 2,
wherein the memory portion has a rewritable memory portion and a non-rewritable memory portion,
wherein the non-rewritable memory portion is capable of storing information in advance, and
wherein the rewritable memory portion is capable of writing and reading information from the wireless signal.

7. The terminal device according to claim 1, wherein the high frequency circuit, the logic portion, the memory portion, and the display portion are formed using a transistor formed over an insulating substrate.

8. The terminal device according to claim 2, wherein the high frequency circuit, the logic portion, the memory portion, and the display portion are formed using a transistor formed over an insulating substrate.

9. The terminal device according to claim 1, wherein electric power needed for operation of circuits of the terminal device is generated by applying wireless communication.

10. The terminal device according to claim 2, wherein electric power needed for operation of circuits of the terminal device is generated by applying wireless communication.

11. The terminal device according to claim 1, further comprises a speaker.

12. The terminal device according to claim 2, further comprises a speaker.

13. The terminal device according to claim 1, wherein the display portion includes a light emitting element or a liquid crystal.

14. The terminal device according to claim 2, wherein the display portion includes a light emitting element or a liquid crystal.

15. A communication system comprising:
a terminal device including an antenna to transmit and receive a wireless signal, a high frequency circuit operationally connected to the antenna, a logic portion to which an output from the high frequency circuit is inputted, a memory portion to store an output from the logic portion, and a display portion to which an output from the logic portion is inputted;
a reader/writer for communication to transmit and receive information to and from the terminal device;
a host computer operationally connected to the reader/writer for communication; and
an information communication means to input and output information to and from the host computer,
wherein the terminal device has a function of displaying information from the information communication means on the display portion.

16. A communication system comprising:
a terminal device including an antenna to transmit and receive a wireless signal, a high frequency circuit operationally connected to the antenna, a logic portion to which an output from the high frequency circuit is inputted, a memory portion to store an output from the logic portion, a display portion to which an output from the logic portion is inputted, and an optical sensor;
a reader/writer for communication to transmit and receive information to and from the terminal device;
a host computer operationally connected to the reader/writer for communication; and
an information communication means to input and output information to and from the host computer,
wherein the terminal device has a function of displaying information from the information communication means on the display portion, and the optical sensor for detecting an amount of external light and controlling a brightness of the display portion according to the amount of external light which is detected.

17. The communication system according to claim 15, wherein the memory portion has a rewritable memory portion and a non-rewritable memory portion.

18. The communication system according to claim 16, wherein the memory portion has a rewritable memory portion and a non-rewritable memory portion.

19. The communication system according to claim 15,
wherein the memory portion has a rewritable memory portion and a non-rewritable memory portion,
wherein the non-rewritable memory portion is capable of storing information in advance, and
wherein the rewritable memory portion is capable of writing and reading information from the wireless signal.

20. The communication system according to claim 16,
wherein the memory portion has a rewritable memory portion and a non-rewritable memory portion,
wherein the non-rewritable memory portion is capable of storing information in advance, and
wherein the rewritable memory portion is capable of writing and reading information from the wireless signal.

21. The communication system according to claim 15, wherein the high frequency circuit, the logic portion, the memory portion, and the display portion are formed using a transistor formed over an insulating substrate.

22. The communication system according to any one of claim 16, wherein the high frequency circuit, the logic portion, the memory portion, and the display portion are formed using a transistor formed over an insulating substrate.

23. The communication system according to claim 15, wherein electric power needed for operation of circuits of the terminal device is generated by applying wireless communication.

24. The communication system according to claim 16, wherein electric power needed for operation of circuits of the terminal device is generated by applying wireless communication.

25. The communication system according to claim 15, wherein the terminal device further comprises a speaker.

26. The communication system according to claim 16, wherein the terminal device further comprises a speaker.

27. The communication system according to claim 15, wherein the display portion includes a light emitting element or a liquid crystal.

28. The communication system according to claim 16, wherein the display portion includes a light emitting element or a liquid crystal.

29. The communication system according to claim 15, wherein a memory portion and a logic portion are provided in the reader/writer for communication to transmit to and receive from the terminal device without exchanging information with the host computer.

30. The communication system according to claim 16, wherein a memory portion and a logic portion are provided in the reader/writer for communication to transmit to and receive from the terminal device without exchanging information with the host computer.

31. The communication system according to claim 15, wherein the information communication means is at least one of the group consisting of a telephone line, an alarm system, and an office network system.

32. The communication system according to claim 16, wherein the information communication means is at least one of the group consisting of a telephone line, an alarm system, and an office network system.
